(19) United States
(12) Patent Application Publication
(10) Pub. No.: US 2016/0196590 A1
(43) Pub. Date: Jul. 7, 2016

(54) SYSTEM AND METHOD FOR SUPPORTING STUDENT ATHLETICS PROGRAMS

(71) Applicant: UBooster, Inc., Greenville, SC (US)

(72) Inventor: Robert Morgan, JR., Greenville, SC (US)

(21) Appl. No.: 14/988,067

(22) Filed: Jan. 5, 2016

Related U.S. Application Data
(60) Provisional application No. 62/099,832, filed on Jan. 5, 2015.

(51) Int. Cl. G06Q 30/02; G06Q 50/20; G06F 17/30; G06Q 20/10

(52) U.S. Cl. CPC G06Q 30/0279; G06Q 20/10; G06Q 50/2053; G06F 17/30867

(57) ABSTRACT

Exemplary embodiments relate to methods, mediums, and systems for facilitating and improving the fundraising efforts of booster clubs or institutions in raising money for student athletics. In addition to providing funding for the institutions and/or athletics programs, exemplary embodiments may provide payment mechanisms that would allow institutions to comply with applicable legislation and court rulings, without dismantling the existing booster-assisted system. In some embodiments, a booster may provide an identification of a student athlete, and a pledged contribution to be paid to an entity (such as a trust fund, the institution, a booster club affiliated with the institution, or the student athlete). The booster may commit to paying the pledged contribution if the student athlete attends the institution. Upon receiving confirmation that the student athlete has committed to attending the institution, a transaction may be initiated to carry out the pledge.

### BACKGROUND

Traditionally, booster clubs have been used to raise money for a sports team or institution (such as a university) associated with the club. The booster club may, for example, collect membership fees, accept donations, or conduct fundraisers to raise money for the team or institution. In the past, money raised by the booster club has been used to pay for trips to events (such as away games), as well as new equipment and facilities, for student athletes.

Booster clubs are typically well-defined entities that may be subject to regulation by the institution associated with the club and/or (at the collegiate level) by the National Collegiate Athletic Association (“NCAA”).

Traditionally, student athletes have been prohibited from directly collecting payment for their athletic performance (enforced, for example, by the NCAA's amateurism rules). Student athletes typically may be compensated (at-most) by a cost-of-tuition scholarship for the institution they attend.

Recent court rulings have suggested that this amateurism model may be untenable under applicable antitrust laws. For example, the recent Northern District of California ruling in O'Bannon v. National Collegiate Athletic Association found that college athletes should be entitled, upon graduation, to receive financial compensation for the NCAA's use of their image, name, and likeness.

One proposed alternative to the current model is to establish a trust fund into which a portion of licensing revenues attributable to a particular college athlete would be paid. Upon graduation, the athlete would be entitled to receive their share of the trust.

However, no mechanism is currently in place to establish, fund, or regulate such a trust. A further problem is that a particular college or university may not have the requisite funds immediately available to place into the trust.

### SUMMARY

The present application relates to methods, mediums, and systems for facilitating and improving the fundraising efforts of booster clubs or institutions in raising money for student athletics. In addition to providing funding for the institutions and/or athletics programs, exemplary embodiments may provide payment mechanisms that would allow the NCAA and/or institutions to comply with applicable legislation and court rulings, without dismantling the current booster-assisted system. In some embodiments, aspects of the existing amateur-based system are leveraged in order to efficiently distribute funds to relevant parties while complying with applicable local laws.

Exemplary embodiments disclosed herein relate to methods, mediums, and systems for contributing to a institution's athletic program. According to exemplary embodiments, an identification of a booster and an institution that the booster wishes to assist may be received. The booster may provide an identification of a student athlete, and a pledged contribution to be paid to an entity (such as a trust fund, the institution, a booster club affiliated with the institution, or the student athlete). By confirming the identification of the student athlete and the pledged contribution, the booster may commit to paying the pledged contribution if the student athlete attends the institution.

Upon receiving a confirmation that the student athlete has committed to attending the institution, a transaction may be performed in the amount of the pledged contribution. Through the transaction, the amount of the pledged contribution may be transferred from the booster to the entity.

In some embodiments, a database may be used to track prospective student athletes, prospective institutions that each student athlete is considering and/or that prospective boosters may supports, and a list of prospective boosters. In response to receiving the identification of the student athlete and the pledged contribution, an entry may be created in the database that associates the identified student athlete with the identified institution and the identified booster. Upon determining that the student athlete has committed to attending the institution, the database may be searched to identify boosters who have pledged to contribute if the student athlete attends the institution.

According to some exemplary embodiments, a list of institutions under consideration by a student athlete may be received. A pledged contribution associated with the student athlete may be accepted only if the pledged contribution can be satisfied by the student athlete attending one of the institutions in the list of institutions. A booster may initiate a search for student athletes who have listed the identified institution in their list of institutions, and such a list may be displayed on a display device.

Using the exemplary embodiments described herein, student athletes may be provided with payment (for example, for the use of their image, name, and likeness) in compliance with applicable laws and regulations. Funding may be provided by members of the public and paid to trusts, or directly to institutions or the student athletes. Thus, the institutions do not need to concern themselves with paying licensing fees directly. At the same time, members of the public can become more engaged with their favored institutions' athletic programs, and can honor a student athlete's selection of an institution through contributions to the institution's athletic program.

These and other advantages will be apparent from the discussion of exemplary embodiments below.

### BRIEF DESCRIPTION OF THE DRAWINGS

FIG. 1 depicts an exemplary environment and system suitable for use with exemplary embodiments of the present invention.

FIGS. 2A-2C are flowcharts describing exemplary procedures suitable for use with exemplary embodiments of the present invention.

FIG. 3 depicts an exemplary interface suitable for use with exemplary embodiments of the present invention.

FIG. 4 depicts an exemplary computer system suitable for use with exemplary embodiments of the present invention.

### DETAILED DESCRIPTION

Exemplary embodiments provide methods, mediums, and systems for collecting pledges from boosters associated with institutions. The pledges will honor a specified student athlete's decision to attend the booster's selected institution. If the student athlete decides to attend an institution with associated pledges from boosters, a transaction may be carried out to withdraw funds from the boosters' accounts. The funds may be paid into trusts for the benefit of the student athlete, and/or may be sent to a booster club associated with the institution or to the institution for the maintenance of the institution's athletic program.

### Exemplary System Overview

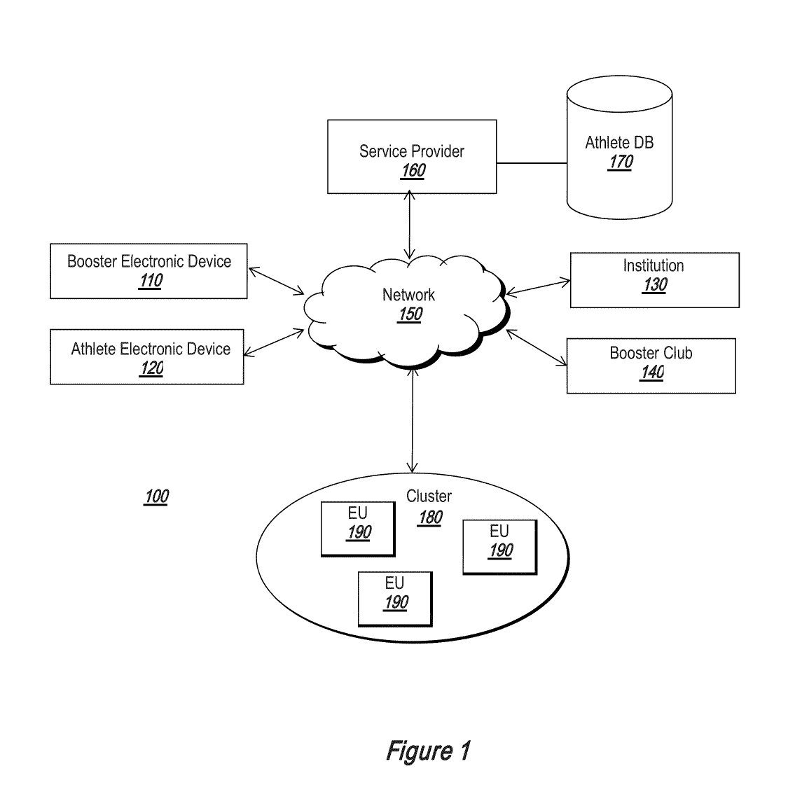

Exemplary embodiments may connect individual boosters, student athletes, institutions, and booster clubs through a networked environment. FIG. 1 depicts an exemplary system and environment 100 suitable for use with exemplary embodiments of the present invention. The embodiment of FIG. 1 is intended to be exemplary, and other embodiments can include more devices, fewer devices, or devices in arrangements that differ from the arrangement of FIG. 1.

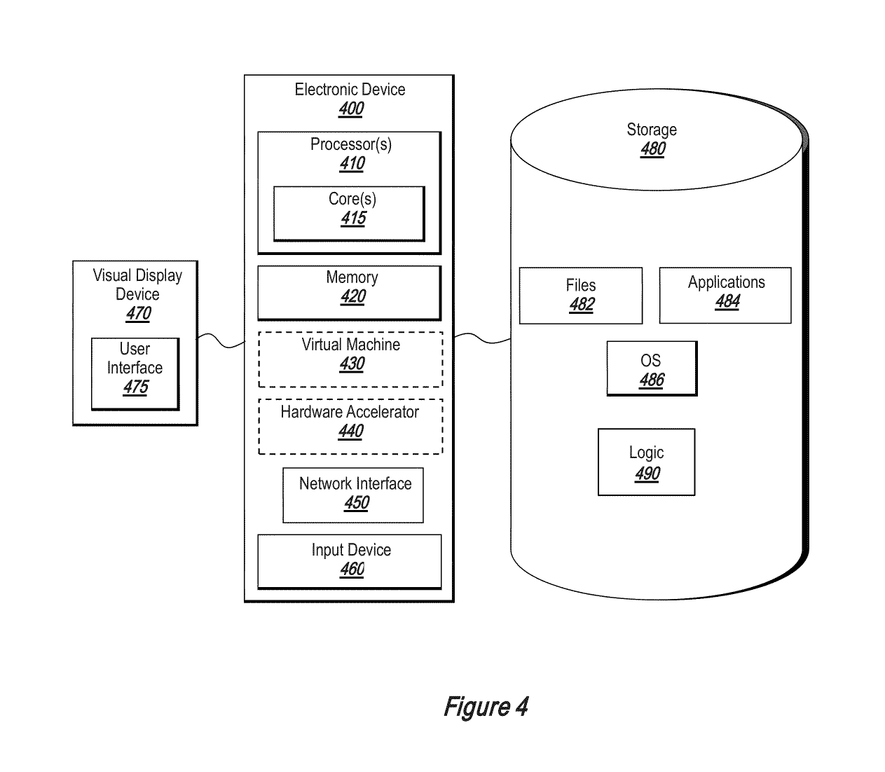

A booster may interact with the system 100 through a booster electronic device 110, such as a mobile phone, laptop, desktop computer, tablet, etc. Similarly, a student athlete may interact with the system 100 through a student athlete electronic device 120. Exemplary electronic devices suitable for use with the present invention are described in more detail with respect to FIG. 4, below.

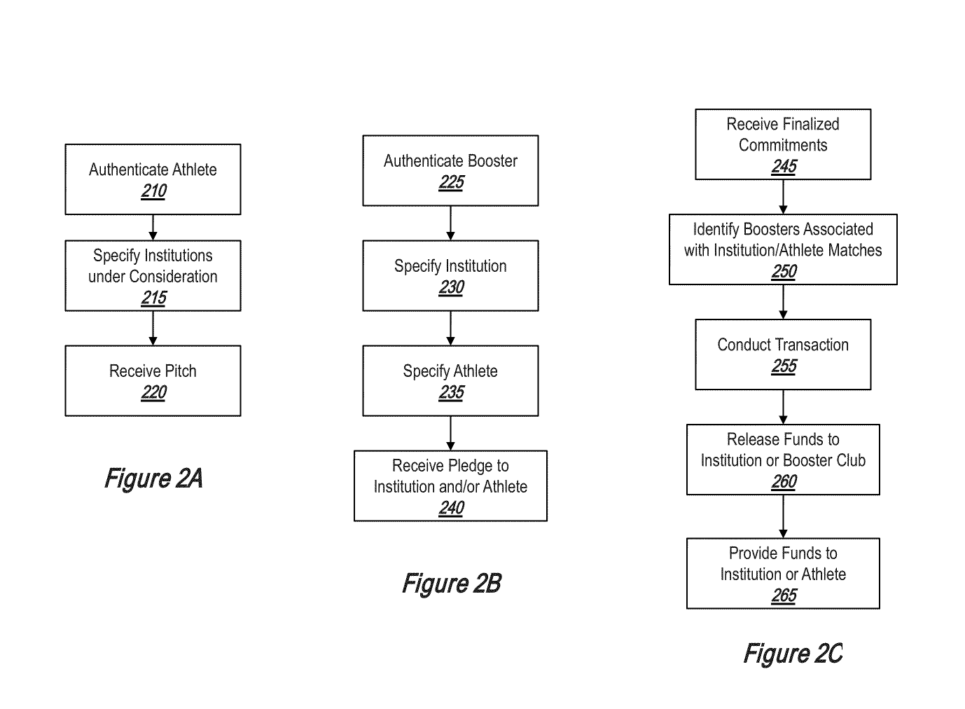

The student athlete electronic device 120 may perform a method for allowing the student athlete to create a list of institutions under consideration by the student athlete, and for submitting a sales pitch to entice boosters to support the student athlete's choice of a particular institution. An exemplary method to be performed by the student athlete electronic device 120 is described below with respect to FIG. 2A.

The booster electronic device 110 may perform a method for allowing the booster to submit pledges to be paid if a particular student athlete attends a specified institution. An exemplary method to be performed by the booster electronic device 110 is described below with respect to FIG. 2B.

The booster may be associated with an institution 130, such as a university, college, professional sports team, or other entity. In some embodiments, the institution 130 may be associated with a booster club 140. The booster interacting with the booster electronic device 110 may or may not be an alumnus of the institution 130, and may or may not be a member of the booster club 140.

The booster electronic device 110, student athlete electronic device 120, institution 130, and booster club 140 may be connected to a network 150, such as the Internet. The network 150 may transport data from a source to a destination. Embodiments of the network 150 may use network devices, such as routers, switches, firewalls, and/or servers (not shown) and connections (e.g., links) to transport data. Data may refer to any type of machine-readable information having substantially any format that may be adapted for use in one or more networks and/or with one or more devices (e.g., the booster electronic device 110, the student athlete electronic device 120, etc.). Data may include digital information or analog information. Data may further be packetized and/or non-packetized.

The network 150 may be a hardwired network using wired conductors and/or optical fibers and/or may be a wireless network using free-space optical, radio frequency (RF), and/or acoustic transmission paths. In one implementation, the network 150 may be a substantially open public network, such as the Internet. In another implementation, the network 150 may be a more restricted network, such as a corporate virtual network. The network 150 may be the Internet, an intranet, Local Area Network (LAN), Wide Area Network (WAN), Metropolitan Area Network (MAN), wireless network (e.g., using IEEE 802.11), or other types of network. The network 150 may use middleware, such as Common Object Request Broker Architecture (CORBA) or Distributed Component Object Model (DCOM). Implementations of networks and/or devices operating on networks described herein are not limited to, for example, any particular data type, protocol, and/or architecture/configuration.

Using the network 150, each of entities communicating with the network 150 may be connected to a service provider 160, which may be a third-party service provider. The service provider 160 may facilitate transactions between the entities connected to the network 150. The service provider 160 may accept lists of institutions under consideration by student athletes, and may further accept athlete pitches, accept pledges from boosters, identify when a student athlete has committed to an institution and evaluate which pledges may be implicated by such a commitment, and carry out related transactions to actualize such pledges. To facilitate these tasks, the service provider 160 may maintain an athlete database 170, which includes entries related to student athletes, institutions, boosters, and booster pledges. An exemplary method to be performed by the service provider 160 is described below with respect to FIG. 2C.

The service provider 160 may include a device that makes a service available to another device. For example, the service provider 160 may include an entity (e.g., an individual, a corporation, an educational institution, a government agency, etc.) that provides one or more services to a destination using a server and/or other devices. Services may include instructions that are executed by a destination to perform an operation (e.g., an optimization operation). Alternatively, a service may include instructions that are executed on behalf of a destination to perform an operation on the destination's behalf.

A cluster 180 may include a number of Execution Units (EUs) 190 and may perform processing on behalf of the electronic devices 110, 120 and/or another device, such as the service provider 160. For example, the cluster 180 may perform parallel processing on an operation received from the service provider 160. The cluster 180 may include EUs 190 that reside on a single device or chip or that reside on a number of devices or chips.

The EUs 190 may include processing devices that perform operations on behalf of a device. An EU may be a microprocessor, field programmable gate array (FPGA), and/or another type of processing device. EU 190 may include code, such as code for an operating environment. For example, an EU 190 may run a portion of an operating environment that pertains to parallel processing activities. The service provider 160 may operate the cluster 190 and may provide interactive optimization capabilities to devices attached to the network 150 on a subscription basis (e.g., via a web service).

EUs 190 may provide remote/distributed processing capabilities for software products. A hardware EU may include a device (e.g., a hardware resource) that may perform and/or participate in parallel programming activities. For example, a hardware EU may perform and/or participate in parallel programming activities in response to a request and/or a task it has received (e.g., received directly or via a proxy). A hardware EU may perform and/or participate in substantially any type of parallel programming (e.g., task, data, stream processing, etc.) using one or more devices. For example, a hardware EU may include a single processing device that includes multiple cores or a number of processors. A hardware EU may also be a programmable device, such as a field programmable gate array (FPGA), an application specific integrated circuit (ASIC), a digital signal processor (DSP), or other programmable device. Devices used in a hardware EU may be arranged in many different configurations (or topologies), such as a grid, ring, star, or other configuration. A hardware EU may support one or more threads (or processes) when performing processing operations.

A software EU may include a software resource (e.g., a technical computing environment) that may perform and/or participate in one or more parallel programming activities. A software EU may perform and/or participate in one or more parallel programming activities in response to a receipt of a program and/or one or more portions of the program. A software EU may perform and/or participate in different types of parallel programming using one or more hardware units of execution. A software EU may support one or more threads and/or processes when performing processing operations.

The term ‘parallel programming’ may be understood to include multiple types of parallel programming, e.g. task parallel programming, data parallel programming, and stream parallel programming. Parallel programming may include various types of processing that may be distributed across multiple resources (e.g., software units of execution, hardware units of execution, processors, microprocessors, clusters, labs) and may be performed at the same time.

For example, parallel programming may include task parallel programming where a number of tasks may be processed at the same time on a number of software units of execution. In task parallel programming, a task may be processed independently of other tasks executing, for example, at the same time.

Parallel programming may include data parallel programming, where data (e.g., a data set) may be parsed into a number of portions that may be executed in parallel using, for example, software units of execution. In data parallel programming, the software units of execution and/or the data portions may communicate with each other as processing progresses.

Parallel programming may include stream parallel programming (sometimes referred to as pipeline parallel programming). Stream parallel programming may use a number of software units of execution arranged, for example, in series (e.g., a line) where a first software unit of execution may produce a first result that may be fed to a second software unit of execution that may produce a second result given the first result. Stream parallel programming may also include a state where task allocation may be expressed in a directed acyclic graph (DAG) or a cyclic graph.

Other parallel programming techniques may involve some combination of task, data, and/or stream parallel programming techniques alone or with other types of processing techniques to form hybrid-parallel programming techniques.

Using the above-described system 100, the respective electronic devices may, individually or in cooperation, perform methods for making and executing pledges to attract student athletes to particular institutions. Moreover, additional methods may support the making and executing of the pledges. Exemplary methods are described in the following section with respect to FIGS. 2A-2C.

### Exemplary Methods

FIG. 2A is a flowchart describing an exemplary method that may be performed by a student athlete electronic device 120 in order to establish that the student athlete is interested in being recruited at one or more institutions.

At step 210, the student athlete may create a new account with the service provider 160, or, if the student athlete already has an existing account, the student athlete may authenticate themselves with credentials they have established with the service provider 160.

Alternatively or in addition, a student athlete's account or profile may be set up by a third party, such as the service provider 160. The service provider 160 may use publicly available information (e.g., a student athlete's name and year of high school graduation) and/or may acquire information from another third party (e.g., a recruiting website). For example, the service provider 160 may contract with a third party information clearinghouse to identify a list of up to five schools being visited by the student athlete.

The process of setting up student athlete accounts or profiles may be carried out in a manner that complies with relevant laws and regulations regarding third-party contact with student athletes.

When a student athlete account is created with the service provider 160, the service provider 160 may cause an entry to be created in the athlete database 170 corresponding to the student athlete. Alternatively or in addition, the athlete database 170 may be pre-populated with entries corresponding to scouted athletes. The student athlete's entry in the database 170 may be populated with fields that specify information, such as the sport that the athlete plays, the position the athlete plays, statistics related to the athlete's previous experience, demographic information about the athlete, etc.

At step 215, one or more institutions under consideration by the student athlete may be specified. The institutions may be institutions that the student athlete is considering attending, and for which the student athlete would like to be eligible to receive pledges. The student athlete electronic device 120 may present an interface allowing a student athlete to search for institutions of interest and/or select institutions from a list.

Upon selecting one or more institutions, the service provider 160 may create a logical association between the entry associated with the student athlete in the athlete database 170 and entries associated with the institutions in the athlete database 170.

At step 220, the student athlete may optionally submit a pitch or marketing statement describing the student athlete's qualifications, skills, and/or interest in the institutions selected at step 215. For example, the student athlete electronic device 120 may provide a freeform text input field for entering the pitch or marketing statement. Alternatively or in addition, the student athlete electronic device 120 may allow the student athlete to upload a file containing the pitch or marketing statement. The service provider 160 may store the pitch or marketing statement in a storage device, and may update the student athlete's entry in the athlete database 170 to include a path or pointer to the location of the pitch or marketing statement. Alternatively or in addition, an entry may be created in the database 170 for directly storing the pitch or marketing statement.

Before, during, or after the actions performed in FIG. 2A, a booster may pledge support to athletes in the athlete database 170. For example, boosters may support athletes by contributing to the institution selected by the athlete on national signing day. FIG. 2B is a flowchart describing an exemplary method that may be performed by a booster electronic device 110 in order to generate a pledge.

At step 225, a booster may create an account with the service provider 160. Alternatively, if the booster has previously created an account with the service provider 160, the booster may authenticate their credentials with the service provider 160 in order to log into their account.

At step 230, the booster may specify an institution that the booster wishes to boost. For example, the booster electronic device 110 may display a list of institutions, and the booster may select one or more of the institutions in the list. Alternatively or in addition, the institution may default to an institution with which the booster is affiliated, such as an institution that the booster attended. In another embodiment, the booster electronic device 110 may provide a search option for allowing the booster to search for institutions meeting certain criteria.

At step 235, the booster may specify an athlete that the booster wishes to support at step 230. The booster may search for the athlete in the athlete database 170 by specifying, for example, one or more of a sport, a position, or statistical thresholds. If the booster is already aware of the athlete that they wish to endorse, the booster may search for the athlete by name.

In one embodiment, the booster may search for an athlete at step 235, and the search results may be filtered based on the athlete-specified institutions that were received at step 215. For example, if the student athlete has specified that they are interested in being recruited to institution A, or if the service provider 160 has separately identified that the student athlete is interested in institution A, then only boosters who indicate at step 230 that they wish to boost institution A will receive the student athlete in their search results. If the student athlete has not specified an interest in institution B (or if the service provider 160 has not identified such an interest), then boosters that wish to boost institution B will not receive the student athlete in their search results.

Alternatively or in addition, the booster may browse a list of all athletes that have indicated an interest (or have had an interest specified for them by the service provider 160) in the institution specified in step 230.

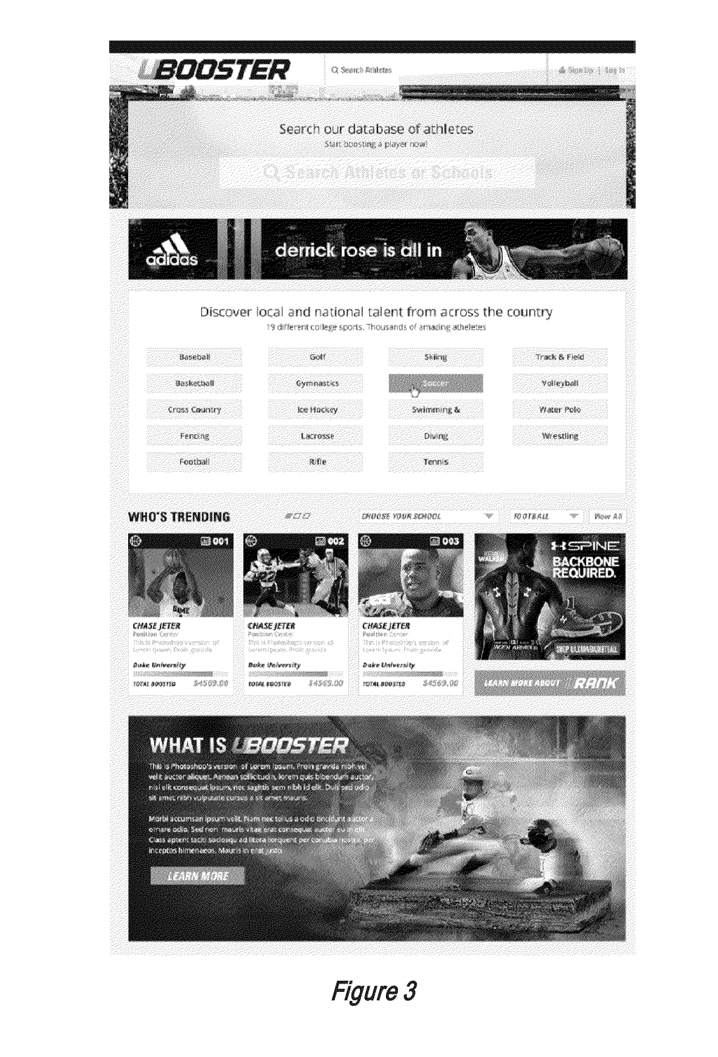

FIG. 3 is an exemplary interface that may be displayed, for example, on the booster electronic device 110 and/or the student athlete electronic device 120. As shown in FIG. 3, the exemplary interface may include search functionality for searching for student athletes. Searches may be filtered by a sport or institution of interest. If a search is filtered by institution, then only student athletes who have indicated an interest in the selected institution may be returned by the search. Moreover, the interface may display trending athletes, which may represent student athletes who have recently been the subject of pledges or who have recently indicated interest in a particular institution.

Returning to FIG. 2B, at step 240 the booster may specify a pledge to be paid if the student athlete specified at step 235 commits to attending the institution specified at step 230. The pledge may be a monetary amount that the booster pledges to pay to honor the athlete's choice of the institution. Optionally, the booster may indicate that some or all of the pledge should be paid to the institution regardless of whether or not the student athlete commits to attending the institution.

The booster may optionally specify an entity to which the pledge should be paid. The entity may be, for example, the institution specified at step 230, the student athlete specified at step 235 (assuming that applicable rules permit payments to student athletes), a trust fund established for the benefit of the institution or the athlete, a booster club associated with the institution, etc.

Once the booster specifies the pledge in step 240, a logical association may be created in the athlete database 170 between the specified student athlete, the booster, the institution, and the amount of the pledge. The booster may also provide transaction information, such as a bank account, credit card, mobile payment account, etc. to be charged in the event that the student athlete commits to attending the institution specified at step 230.

Once the student athlete commits to attending an institution, pledges that were made in support of that athlete attending that institution may be collected. FIG. 2C depicts an exemplary method that may be performed by the service provider 160 in order to carry out the pledges.

At step 245, finalized commitments may be uploaded to the service provider. The finalized commitments may be retrieved from a central source, may be entered by the student athletes themselves, and/or may be manually entered by an administrator associated with the service provider.

At step 250, the service provider 160 may identify boosters associated with pledges that are fulfilled by the student athlete's commitment. For example, the service provider 160 may search the athlete database 170 for logical associations between the student athlete, the institution, and a booster pledge. Any relevant pledges may be retrieved.

Only those pledges which are fulfilled by the student athlete attending the institution may be identified at step 250. Boosters that pledged funds to recruit a student athlete to different institutions are not charged the amount of their pledges, unless the booster specified at step 240 that some or all of the pledge should be carried out regardless of whether the student athlete committed to attending the institution.

At step 255, the service provider 160 may conduct transactions associated with the fulfilled pledges. For example, the service provider 160 may retrieve the transaction information specified at step 240, and may charge the identified account/credit card the amount of money specified in the pledged.

At step 260, the service provider 160 may transfer the funds collected at step 255 to the entity specified at step 240. Optionally, the service provider 160 may aggregate multiple transactions from step 255 and pay the entity in one or more lump sums.

Optionally, at step 265 the funds may be released from the entity to another entity. For example, if the booster specified that the funds should be provided to a booster club, then the booster club may release the funds to the institution associated with the booster club at step 265. Alternatively, if the booster specified that the funds should be provided to an institution or trust fund for the benefit of the student athlete, then at step 265 the funds may be released to the student athlete.

Optionally, the booster, the institution, or another entity (such as the NCAA) may specify a time at which the funds should be released at step 265. For example, the student athlete may need to graduate from the institution before the funds are released to the student athlete. Alternatively or in addition, the student athlete may need to meet certain specified goals, such as achieving a certain grade point average over a specified period of time, before the funds are released.

Although exemplary embodiments have been described above with respect to college athletics, one of ordinary skill in the art will recognize that the present invention is not so limited. For example, the same concept could be applied to professional athletics, in which fans of a particular team pledge money to bring identified players to their team. Such a configuration would allow fans to have a direct influence on, and stake in, the team's players without the intervening influence of team owners or managers. Alternatively or in addition, the exemplary embodiments may also be used to pledge funds for the recruitment of specified coaches or managers, rather than athletes.

### Computer-Implemented Embodiments

One or more of the above-described acts may be encoded as computer-executable instructions executable by processing logic. The computer-executable instructions may be stored on one or more non-transitory computer readable media. One or more of the above described acts may be performed in a suitably-programmed electronic device. FIG. 4 depicts an example of an electronic device 400 that may be suitable for use with one or more acts disclosed herein.

The electronic device 400 may take many forms, including but not limited to a computer, workstation, server, network computer, optical computer, Internet appliance, mobile device, a pager, a tablet computer, a smart sensor, application specific processing device, etc.

The electronic device 400 is illustrative and may take other forms. For example, an alternative implementation of the electronic device 400 may have fewer components, more components, or components that are in a configuration that differs from the configuration of FIG. 4. The components of FIG. 4 and/or other figures described herein may be implemented using hardware based logic, software based logic and/or logic that is a combination of hardware and software based logic (e.g., hybrid logic); therefore, components illustrated in FIG. 4 and/or other figures are not limited to a specific type of logic.

The processor 410 may include hardware based logic or a combination of hardware based logic and software to execute instructions on behalf of the electronic device 400. The processor 410 may include logic that may interpret, execute, and/or otherwise process information contained in, for example, the memory 420. The information may include computer-executable instructions and/or data that may implement one or more embodiments of the invention. The processor 410 may comprise a variety of homogeneous or heterogeneous hardware. The hardware may include, for example, some combination of one or more processors, microprocessors, field programmable gate arrays (FPGAs), application specific instruction set processors (ASIPs), application specific integrated circuits (ASICs), complex programmable logic devices (CPLDs), graphics processing units (GPUs), or other types of processing logic that may interpret, execute, manipulate, and/or otherwise process the information. The processor may include a single core or multiple cores 415. Moreover, the processor 410 may include a system-on-chip (SoC) or system-in-package (SiP). An example of a processor 410 is the Intel® Xeon® processor available from Intel Corporation, Santa Clara, Calif.

The electronic device 400 may include one or more tangible non-transitory computer-readable storage media for storing one or more computer-executable instructions or software that may implement one or more embodiments of the invention. The non-transitory computer-readable storage media may be, for example, the memory 420 or the storage 480. The memory 420 may comprise a RAM that may include RAM devices that may store the information. The RAM devices may be volatile or non-volatile and may include, for example, one or more DRAM devices, flash memory devices, SRAM devices, zero-capacitor RAM (ZRAM) devices, twin transistor RAM (TTRAIVI) devices, read-only memory (ROM) devices, ferroelectric RAM (FeRAIVI) devices, magneto-resistive RAM (MRAM) devices, phase change memory RAM (PRAM) devices, or other types of RAM devices.

The electronic device 400 may include a virtual machine (VM) 430 for executing instructions loaded in the memory 420. A virtual machine 430 may be provided to handle a process running on multiple processors so that the process may appear to be using only one computing resource rather than multiple computing resources. Virtualization may be employed in the electronic device 400 so that infrastructure and resources in the electronic device may be shared dynamically. Multiple VMs 430 may be resident on a single computing device 400.

A hardware accelerator 440, may be implemented in an ASIC, FPGA, or some other device. The hardware accelerator 440 may be used to reduce the general processing time of the electronic device 400.

The electronic device 400 may include a network interface 450 to interface to a Local Area Network (LAN), Wide Area Network (WAN) or the Internet through a variety of connections including, but not limited to, standard telephone lines, LAN or WAN links (e.g., T1, T3, 56 kb, X.25), broadband connections (e.g., integrated services digital network (ISDN), Frame Relay, asynchronous transfer mode (ATM), wireless connections (e.g., 802.11), high-speed interconnects (e.g., InfiniBand, gigabit Ethernet, Myrinet) or some combination of any or all of the above. The network interface 450 may include a built-in network adapter, network interface card, personal computer memory card international association (PCMCIA) network card, card bus network adapter, wireless network adapter, universal serial bus (USB) network adapter, modem or any other device suitable for interfacing the electronic device 400 to any type of network capable of communication and performing the operations described herein.

The electronic device 400 may include one or more input devices 460, such as a keyboard, an interactive whiteboard, a multi-point touch interface, a pointing device (e.g., a mouse), a gyroscope, an accelerometer, a haptic device, a tactile device, a neural device, a microphone, or a camera that may be used to receive input from, for example, a user. Note that electronic device 400 may include other suitable I/O peripherals.

The input devices 460 may allow a user to provide input that is registered on a visual display device 470. A graphical user interface (GUI) 475 may be shown on the display device 470.

A storage device 480 may also be associated with the electronic device 400. The storage device 480 may be accessible to the processor 410 via an I/O bus. The information in the storage device 480 may be executed, interpreted, manipulated, and/or otherwise processed by the processor 410. The storage device 480 may include, for example, a magnetic disk, optical disk (e.g., CD-ROM, DVD player), random-access memory (RAM) disk, tape unit, and/or flash drive. The information may be stored on one or more non-transient tangible computer-readable media contained in the storage device. This media may include, for example, magnetic discs, optical discs, magnetic tape, and/or memory devices (e.g., flash memory devices, static RAM (SRAM) devices, dynamic RAM (DRAM) devices, or other memory devices). The information may include data and/or computer-executable instructions that may implement one or more embodiments of the invention

The storage device 480 may be used for storing one or more files 482 and applications 484. The electronic device 410 can further be running an operating system (OS) 486. Examples of OS 486 may include the Apple iOS, Google Android, Microsoft Windows operating systems, the Unix and Linux operating systems, the MacOS for Macintosh computers, an embedded operating system, such as the Symbian OS, a real-time operating system, an open source operating system, a proprietary operating system, operating systems for mobile electronic devices, or other operating system capable of running on the electronic device and performing the operations described herein. The operating system may be running in native mode or emulated mode.

Additionally, the storage device 480 may store logic 490 for carrying out any of the above-described actions.

One or more embodiments of the invention may be implemented using computer-executable instructions and/or data that may be embodied on one or more non-transitory tangible computer-readable mediums. The mediums may be, but are not limited to, a hard disk, a compact disc, a digital versatile disc, a flash memory card, a Programmable Read Only Memory (PROM), a Random Access Memory (RAM), a Read Only Memory (ROM), Magnetoresistive Random Access Memory (MRAM), a magnetic tape, or other computer-readable media.

One or more embodiments of the invention may be implemented in a programming language. Some examples of languages that may be used include, but are not limited to, Python, C, C++, C#, SystemC, Java, Javascript, a hardware description language (HDL), unified modeling language (UML), and Programmable Logic Controller (PLC) languages. Further, one or more embodiments of the invention may be implemented in a hardware description language or other language that may allow prescribing computation. One or more embodiments of the invention may be stored on or in one or more mediums as object code. Instructions that may implement one or more embodiments of the invention may be executed by one or more processors. Portions of the invention may be in instructions that execute on one or more hardware components other than a processor.

The foregoing description may provide illustration and description of various embodiments of the invention, but is not intended to be exhaustive or to limit the invention to the precise form disclosed. Modifications and variations may be possible in light of the above teachings or may be acquired from practice of the invention. For example, while a series of acts has been described above, the order of the acts may be modified in other implementations consistent with the principles of the invention. Further, non-dependent acts may be performed in parallel.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware.

Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

No element, act, or instruction used in the description of the invention should be construed critical or essential to the invention unless explicitly described as such. Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, an electronic device (e.g., a workstation) or a user of a electronic device, unless otherwise stated.

It is intended that the invention not be limited to the particular embodiments disclosed above, but that the invention will include any and all particular embodiments and equivalents falling within the scope of the following appended claims.

1. A computing-device implemented method comprising:
receiving, using a processor, an identification of a booster and an institution;
receiving an identification of a student athlete and a pledged contribution to be paid to an entity, wherein the booster commits to paying the pledged contribution if the student athlete attends the institution;
receiving a confirmation that the student athlete has committed to attending the institution; and
in response to receiving the confirmation, performing a transaction in an amount of the pledged contribution to transfer the amount from the booster to the entity.

2. The method of claim 1, wherein the entity is the institution.

3. The method of claim 1, wherein the entity is a booster club affiliated with the institution.

4. The method of claim 1, wherein the entity is a trust fund associated with the student athlete.

5. The method of claim 1, further comprising:
accessing a database comprising: prospective student athletes, prospective institutions, and prospective boosters;
in response to receiving the identification of the student athlete and the pledged contribution, creating an entry in the database associating the identified student athlete, the identified institution, and the identified booster; and
upon determining that the student athlete has committed to attending the institution, searching the database to identify boosters who have pledged to contribute if the student athlete attends the institution.

6. The method of claim 1, further comprising:
receiving a list of institutions under consideration by the student athlete; and
accepting pledged contributions associated with the student athlete only if the pledged contribution can be satisfied by the student athlete attending one of the institutions in the list of institutions.

7. The method of claim 6, further comprising:
searching for student athletes who have listed the identified institution in their list of institutions; and
displaying a list of student athletes who have listed the identified institution in their list of institutions.

8. A system comprising:
a non-transitory memory device storing a database storing: prospective student athletes, prospective institutions, and prospective boosters; and
a processor configured to:
receive an identification of a booster and an institution;
receive an identification of a student athlete and a pledged contribution to be paid to an entity, wherein the booster commits to paying the pledged contribution if the student athlete attends the institution;
receive a confirmation that the student athlete has committed to attending the institution; and
in response to receiving the confirmation, perform a transaction in an amount of the pledged contribution to transfer the amount from the booster to the entity.

9. The system of claim 8, wherein the entity is the institution.

10. The system of claim 8, wherein the entity is a booster club affiliated with the institution.

11. The system of claim 8, wherein the entity is a trust fund associated with the student athlete.

12. The system of claim 8, wherein the processor is further configured to:
access the database;
in response to receiving the identification of the student athlete and the pledged contribution, create an entry in the database associating the identified student athlete, the identified institution, and the identified booster; and
upon determining that the student athlete has committed to attending the institution, search the database to identify boosters who have pledged to contribute if the student athlete attends the institution.

13. The system of claim 8, wherein the processor is further configured to:
receive a list of institutions under consideration by the student athlete; and
accept pledged contributions associated with the student athlete only if the pledged contribution can be satisfied by the student athlete attending one of the institutions in the list of institutions.

14. The system of claim 13, wherein the processor is further configured to:
search for student athletes who have listed the identified institution in their list of institutions; and
display a list of student athletes who have listed the identified institution in their list of institutions.

15. A non-transitory computing device readable medium storing instructions that, when executed by a processor, cause the processor to:
receive an identification of a booster and an institution;
receive an identification of a student athlete and a pledged contribution to be paid to an entity, wherein the booster commits to paying the pledged contribution if the student athlete attends the institution;
receive a confirmation that the student athlete has committed to attending the institution; and
in response to receiving the confirmation, perform a transaction in an amount of the pledged contribution to transfer the amount from the booster to the entity.

16. The medium of claim 15, wherein the entity is the institution.

17. The medium of claim 15, wherein the entity is a booster club affiliated with the institution.

18. The medium of claim 15, wherein the entity is a trust fund associated with the student athlete.

19. The medium of claim 15, wherein the processor is further configured to:
access a database storing: prospective student athletes, prospective institutions, and prospective boosters;
in response to receiving the identification of the student athlete and the pledged contribution, create an entry in the database associating the identified student athlete, the identified institution, and the identified booster; and
upon determining that the student athlete has committed to attending the institution, search the database to identify boosters who have pledged to contribute if the student athlete attends the institution.

20. The medium of claim 15, wherein the processor is further configured to:
receive a list of institutions under consideration by the student athlete; and
accept pledged contributions associated with the student athlete only if the pledged contribution can be satisfied by the student athlete attending one of the institutions in the list of institutions.
